(19) United States
(12) Patent Application Publication
(10) Pub. No.: US 2015/0375753 A1
(43) Pub. Date: Dec. 31, 2015

(54) METHOD AND BEAM SENSOR MODULE FOR PREDICTIVELY DETERMINING THE CONDITION OF THE ROAD IN A VEHICLE

(71) Applicants: CONTINENTAL TEVES AG & CO. OHG, Frankfurt (DE); Conti Temic Microelectronic GmbH, Nurnberg (DE)

(72) Inventors: Sighard Schräbler, Karben (DE); Bernd HARTMANN, Bad Homburg (DE); Marc MENZEL, Weimar (Lahn) (DE); Hans MAGNUSSON, Torslanda (SE)

(21) Appl. No.: 14/767,067

(22) PCT Filed: Feb. 10, 2014
(86) PCT No.: PCT/EP2014/052528

§ 371 Date: Aug. 11, 2015

(30) Foreign Application Priority Data
Feb. 12, 2013 (DE) 10 2013 002 333.5

(51) Int. Cl. B60W 40/06; G01N 21/55; G01N 21/3563

(52) U.S. Cl. CPC B60W 40/06; G01N 21/3563; G01N 21/55; B60W 2420/52; G01N 2201/06113; G01N 2201/0697

(57) ABSTRACT

A method for determining the condition of the road ahead in a vehicle, according to which method the road surface is illuminated with sensor beams the sensor beams being reflected and absorbed in accordance with the condition of the road surface and the condition of the road being determined on the basis of the reflected sensor beams. The method is characterized in that the road surface in front of the vehicle in the direction of travel is illuminated. The invention also relates to a corresponding beam sensor module.

### CROSS REFERENCE TO RELATED APPLICATIONS

This application is the U.S. National Phase of PCT/EP2014/052528, filed Feb. 10, 2014, which claims priority to German Patent Application No. 10 2013 002 333.5, filed Feb. 12, 2013, the contents of such applications being incorporated by reference herein.

### FIELD OF THE INVENTION

The invention relates to a method for predictively determining the condition of the road in a vehicle, and to a beam sensor module for predictively determining the condition of the road in a vehicle.

### BACKGROUND OF THE INVENTION

In the prior art, a multiplicity of different sensor systems for sensing the environment are already known for the field of motor vehicles. By means of these sensor systems it is possible, for example, to detect other vehicles, road signs as well as lane boundaries. The sensors used in this context are often camera sensors, lidar sensors, laser sensors or radar sensors. The environmental information which is sensed in this way can be used, inter alia, for safety-relevant interventions such as, for example, autonomous braking interventions or steering interventions. Furthermore, vehicle sensors are known which primarily determine a condition of the vehicle, but also permit conclusions to be drawn about environmental conditions such as, for example inclination sensors.

In this context, DE 10 2007 062 203 A1, which is incorporated by reference, discloses a method for determining a coefficient of friction between a motor vehicle tire and the surface of a roadway during acceleration of the vehicle. In this context, a first coefficient of friction parameter is determined using a model, wherein a functional relationship is predefined between the first coefficient of friction parameter and a slip of the motor vehicle tire which is determined in a drive-dependent fashion. Furthermore, a second coefficient of friction parameter is determined from the quotient between the longitudinal force and a contact force of the motor vehicle tire, and finally the coefficient of friction is determined from the first and second coefficient of friction parameters by means of a recursive estimation algorithm. The slip is determined here from the rotary wheel speeds, the longitudinal force from a determined engine torque and the contact force from a longitudinal acceleration and a lateral acceleration. The rotary wheel speeds are in turn usually determined by means of an ABS sensor system.

DE 10 2009 008 959, which is incorporated by reference, discloses a vehicle system for navigating and/or providing driver assistance. The vehicle system provides the driver with information on the surroundings over a so-called virtual horizon, which information about the surroundings also includes environmental information which is sensed by means of a sensor and which permits conclusions to be drawn about the condition of the road. For this purpose, a low coefficient of friction can be detected, for example by means of an electronic brake system in the case of a braking process. Wetness can be detected by means of a rain sensor or by means of activation of the windshield wipers. Potential icing up of the road can be detected, for example, from the combination of temperatures near to freezing point and the passing of a bridge.

DE 10 2012 203 187 A1, which is incorporated by reference, describes a method for predicting and adapting movement trajectories of a motor vehicle for assisting the driver in his driving task and/or for preventing a collision or reducing the consequences of an accident. In this context, braking and/or steering interventions are provided which are made in the braking and/or steering system as a function of a calculated movement trajectory. In order to ensure that the wheel forces which result from the movement trajectories as a result of combined braking and/or steering interventions are below the maximum available coefficient of friction at all times, said coefficient of friction is determined by means of optical roadway sensors such as laser sensors and/or camera sensors. Likewise, determination of the maximum available coefficient of friction is described by means of driving dynamics control systems, driving stability control systems, slip control systems and the inclusion of information from rain sensors, temperature sensors or tire sensors, as well as information received by means of car-to-X communication.

DE 10 2011 015 527 A1, which is incorporated by reference, discloses a sensor for determining a condition of a roadway surface for a motor vehicle. The condition may be in this context a state such as wet, dry, icy, covered with snow or a combination thereof. The sensor comprises a light source unit which emits light with at least two different wavelengths, and at least two detectors for sensing the reflected light of the light source unit. Since the different wavelengths are reflected to differing degrees depending on the condition of the roadway surface, a conclusion can be drawn about the state of the roadway surface from the reflected light. The described sensor is suitable for detecting the condition of a roadway surface which is subjected to irradiation essentially perpendicularly at a distance of 10 cm to 100 cm.

### SUMMARY OF THE INVENTION

However, a disadvantage with the methods and devices which are known from the prior art is that a condition of the road cannot be determined directly in many cases but instead is merely derived from other parameters such as, for example, temperature and wetness. Insofar as the condition of the road is to be sensed directly according to the prior art, this is essentially possible only indirectly when the section of road to be investigated is traveled through. In particular, when optical sensors are used for sensing the condition of the road, according to the prior art they are mounted on the underside of the vehicle and directed at the road surface underneath the vehicle. However, this limits the effectiveness of driving dynamics control systems since they do not have directly measured predictive information about the condition of the road.

Therefore an aspect of the invention is a method which permits the condition of the road to be determined predictively.

An aspect of the invention relates to a method for predictively determining the condition of the road in a vehicle in which a road surface is illuminated with sensor beams, wherein the sensor beams are reflected and absorbed in accordance with a condition of the road surface, and wherein the condition of the road is determined on the basis of the reflected sensor beams. The method is defined in that the road surface is illuminated in front of the vehicle in the direction of travel.

The term condition of the road is understood in the sense of the invention as meaning different states of the road surface in terms of its coefficient of friction, in particular, the states “wet”, “dry”, “covered with ice” and “covered with snow” are differentiated, wherein combinations of the specified road states are also possible. For example, a puddle of water can cover a layer of ice, with the result that a combination of the road states of “wet” and “covered with ice” can be present and would be detected correspondingly.

According to an aspect of the invention, the condition of the road is therefore determined not only directly under the vehicle but also predictively ahead of the vehicle. This provides the advantage that the determined condition of the road can be made available early to, for example, a driving stability control system. The driving stability control system can therefore be prepared in good time and in a situation-specific fashion for a critical situation before said situation occurs. By taking into account the current speed of the vehicle and the set range of the sensor beams it is additionally possible to determine the time by which the respectively illuminated road surface will be travelled over, with the result that a driving stability control system can be set in a way which is largely adapted in an optimum fashion to all the detected road states.

Likewise, a warning can be predictively output to the driver in order to inform him, for example, that he will shortly travel over an ice-covered road surface and correspondingly should avoid violent steering maneuvers or braking processes or acceleration processes.

There is preferably provision that the road surface is illuminated and the reflected sensor beams are sensed in a synchronized pulsed fashion. On the one hand, an average output radiation power can therefore be reduced, which contributes to increasing the service life of the beam element which is used. In addition the risk of causing damage to the eyes of people or animals looking into the sensor beams is reduced. At the same time, the energy of an individual light pulse can be significantly greater than the quantity of energy which is output in the continuous operating mode in the same period of time, as a result of which the signal-to-noise ratio of the information in the reflected sensor beams is greatly improved during the determination of the condition of the road. In particular, for the improvement of the signal-to-noise ratio it is important here that the sensing occurs in synchronism with the illumination.

Furthermore, it is preferred that the sensor beams comprise different wavelengths, in particular laser beams with maximum intensity values at at least two different wavelengths. This simplifies the determination and, in particular, the differentiation of different road states. When laser beams are used with maximum intensity values at at least two different wavelengths, these advantages are further boosted by the comparatively high light intensity of the laser beams in a comparatively narrow wavelength band.

In particular it is preferred that the condition of the road is determined on the basis of intensity values of the different wavelengths in the reflected sensor beams. Since the different states of the road surface have different optical properties and correspondingly act in an absorbing fashion for certain wavelengths and in a reflecting fashion for others, the respective condition of the illuminated road surface can be inferred from the reflected sensor beams. An example of this is, for example, the wavelength 1550 nm, which is absorbed by ice to a comparatively high degree.

Furthermore, it is particularly preferred that the different wavelengths in the reflected sensor beams 120 are assigned to the condition of the road by means of stochastic assignment methods, in particular by means of a support vector method and/or a k-means algorithm. This gives rise to comparatively more reliable detection of different road states than is possible with rigidly predefined limiting values for the detection. Above all, it has become apparent that with respect to the detection of combinations of simultaneously present road states such as, for example, a layer of snow which is located above a layer of water this introduced significant improvements with respect to reliable detection. The detection of such a combination of road states is of increased significance insofar as a layer of ice which lies under the layer of snow constitutes a significantly greater risk for the driving stability of the vehicle than is apparent from the layer of snow lying above. A person skilled in the art is aware in this context of different suitable stochastic assignment methods which permit an assignment to the respective condition of the road while taking into account properties of the reflected sensor beams such as variances, standard deviations and mean values. In particular, the person skilled in the art is aware of what are referred to as support vector methods which represent the information in the reflected sensor beams in a multi-dimensional space, and whose spatial distribution permits reliable determination of the condition of the road. These support vector methods generally permit the efficient determination of the location of global minimum values without in the process being disrupted by local minimum values which occur. This is achieved, in particular, by utilizing a multi-dimensional vector space. A further advantage of the support vector methods is that they require comparatively little electronic computing power. A person skilled in the art is also aware of the fact that what are referred to as k-means algorithms, which assign elements from a set of similar objects to a predefined number of different groups. The k-means algorithms are therefore often also used for what is referred to as cluster analysis. Furthermore, there is preferably provision that the different road states are initially learnt by means of a learning method. This also improves the reliability during the detection of the different road states.

Furthermore, there is provision that a specific condition of the road is passed on to at least one driving stability control system and/or driving dynamics control system, in particular to an anti-lock brake system and/or an electronic stability program and/or a ride level control system, wherein the at least one driving stability control system and/or driving dynamics control system carries out control which is adapted in a location-synchronous fashion by means of the specific condition of the road. The control of such a driving stability control system or driving dynamics control system is therefore improved, since, as already described, it already knows in advance the expected coefficient of friction of the road surface and can set correspondingly presetting as a starting point for a subsequent control. Control which is adapted in a location-synchronous fashion is understood according to the invention to mean that the time when the respective point on the road surface, the condition of which road has been determined, is travelled through is acquired taking into account the vehicle speed, and therefore the corresponding presetting can respectively be made in each case in synchronism with the travel through this point.

An aspect of the invention also relates to a beam sensor module for predictively determining the condition of the road in a vehicle, which comprises at least two beam elements, at least one detector element, an analysis module and a sensor housing, wherein the at least two beam elements illuminate a road surface with sensor beams, wherein the sensor beams are reflected and absorbed in accordance with a condition of the road surface, wherein the at least one detector element senses the reflected sensor beams, and wherein the analysis module determines the condition of the road on the basis of the reflected sensor beams sensed by at least one detector element. The beam sensor module is defined in that the sensor housing is designed for attachment to an inner side of a vehicle windshield.

The sensor housing comprises here the beam elements, the detector element and, if appropriate, the analysis module wherein the analysis module can also be arranged outside the sensor housing. The sensor housing is preferably open toward one side. The open side is closed by the vehicle windshield only as a result of the attachment of the sensor housing to the windshield.

The beam sensor module is preferably attached to the inner side of the vehicle windshield at the level of the base of the rearview mirror. In this position, it does not restrict the driver's view toward the front and has good illumination conditions for the road surface ahead of the vehicle. A further advantage of this attachment position is that the open side of the sensor housing through which the sensor beams are output and sensed is regularly cleaned by the windshield wiper or wipers of the vehicle. This ensures that the beam sensor module is not adversely affected in its method of functioning by soiling in the beam path of the sensor beams. On the other hand, this is not the case with the optical sensors from the prior art which are usually attached under the vehicle.

Since the beam sensor module illuminates the road surface in the direction of travel ahead of the vehicle owing to its attachment, this also produces the advantages already mentioned in this context.

It is preferred that the beam elements are semiconductor lasers with different wavelengths in the wavelength range from 900 nm to 1700 nm, in particular with maximum intensity values at the wavelengths 980 nm and/or 1310 nm and/or 1550 nm. These wavelengths are all in what is referred to as the infrared spectral range and are therefore not visible to the human eye, but they nevertheless constitute a danger, since they can nevertheless damage the human eye. This avoids irritating other road users. The specified wavelengths also provide the advantage that they can be generated by means of semiconductor lasers, wherein, in particular, gallium-arsenide-based semiconductor lasers and indium-phosphite-based semiconductor lasers are suitable for this. Germanium-based semiconductor lasers are also suitable. Semiconductor lasers are comparatively cost-effective and very compact components with a high radiation power.

If only a single detector element is used for sensing the reflected sensor beams, it is preferably provided that the beam elements be operated in a chronologically offset fashion, with the result that in each case just one beam element is operational and correspondingly just one wavelength is emitted or reflected. The analysis module knows the respective operating times of the individual beam elements here. The different wavelengths can therefore be evaluated in chronological succession.

Furthermore it is preferred that a radiation power of the at least two beam elements does not exceed 1 mW in each case, wherein the radiation power is determined, in particular, at an outer side of the windshield. This ensures that damage to the eyes of people and of animals owing to the radiation power is avoided. Since the radiation power is only determined on the outside of the windshield and is set to 1 mW, in addition no radiation power which can be used without danger is allowed to pass unused through the windshield as a result of back radiation effects. Since a reduced radiation power also entails a reduction in the possible sensor range, the radiation power is preferably determined at the outside of the windshield and set to 1 mW. The maximum possible radiation power which is not dangerous for the human eye is therefore used. 40% to 60% of the radiation power is usually reflected directly back into the beam sensor module through the windshield.

In particular it is preferred that the radiation power is output in a pulsed fashion. Since the radiation power which is output on average is decisive for damage to the eye of a person or animal, during the “on phases” of the beam elements a very much higher level of energy can therefore be output for a short time than would be possible with continuous operation in the same time period without exceeding the radiation power of 1 mW. With respect to the reliability of the determination of a condition of the road, it is furthermore thus possible to achieve a significant improvement, since the signal-to-noise ratio of the information in the reflected sensor beams is increased during the determination of the condition of the road. As a result, the range of the beam sensor module within which reliable determination of the condition of the road is possible is in turn increased.

It is advantageous that the detector element determines a portion of the radiation power which is reflected back into the beam sensor module by the windshield, and the beam sensor module controls the radiation power at the outer side of the vehicle windshield on the basis of the portion which is reflected back. This provides the advantage that the maximum possible radiation power which is still unharmful for the human eye is always available for the determination of the condition of the road. For example, aging effects of the beam elements can therefore be compensated.

In particular, it is advantageous that the beam elements are switched off if no back reflections are detected anymore. In this case, it must be possible to assume that the vehicle windshield is no longer located in front of the beam sensor module, for example owing to an accident of the vehicle or a repair in a workshop. In order to avoid injuries to eyes, the beam elements are switched off in this situation.

Furthermore it is advantageous that the beam sensor module comprises, for each beam element a separate detector element whose respective maximum sensitivity value corresponds to the wavelength of the maximum intensity value of the respective beam element. It is therefore possible to carry out simultaneous analysis of the reflected sensor beams, which can therefore also be emitted simultaneously. Chronologically offset actuation of the beam elements and synchronization of the detector element are therefore not necessary. In addition, in this case detector elements can be used which have their respective maximum sensitivity value of the wavelength at the wavelength of the maximum intensity value of the respective beam element, which permits comparatively more reliable determination of the condition of the road and a larger range of the beam sensor module. However, since the detector element constitutes a comparatively expensive component of the beam sensor module, an individual detector element can also be used which has a sufficiently wide sensitivity range to detect the different wavelengths of the different beam elements. In the latter case, the use of wavelength-dependent correction factors may be appropriate.

There is expediently provision that the detector element is a photodiode, in particular an indium-gallium-arsenide-based photodiode or a germanium-based photodiode. Photodiodes generate an electric current which is dependent on the wavelength of light and the intensity of the light which is incident on it. Therefore, photodiodes are very well suited as detector elements according to the invention. The current which is generated is here a measurement variable of the reflected or absorbed sensor beams. When a germanium-based photodiode is used as detector element, said photodiode is preferably cooled, for example by means of a Peltier element.

There is expediently provision that the beam sensor module also comprises a blocking filter for visible light, which blocking filter screens the detector element. This reduces interference influences and prevents incorrect detections. The range within which reliable determination of the condition of the road is possible can therefore be increased.

There is preferably provision that the beam sensor module also comprises at least one collecting lens which focuses the reflected sensor beams onto the at least one detector element. The intensity of the reflected sensor beams which is directed onto the detector is therefore increased. This also brings about more reliable determination of the condition of the road and increases the effective sensor range of the beam sensor module. It is to be noted that it is necessary to select suitable materials for the at least one collecting lens, which materials do not absorb the infrared sensor beams.

There is expediently provision that the beam sensor module comprises a connection to a vehicle bus, and, in particular, passes on information about a detected condition of the road to at least one further vehicle system. The information about the detected condition of the road can therefore be made available to a further vehicle system, for example a driving stability control system. Since said system is already supplied in a predictive fashion with information about the respective directly following road states, said system can also determine in a predictive fashion the coefficient of friction which is expected between the road surface and the tire, and can set itself thereto. This simplifies the driving stability control and an increase in driving stability and driving safety is obtained compared to systems which cannot determine the coefficient of friction until the respective road surface is directly travelled on, and cannot set themselves predictively to said coefficient of friction.

There is advantageously provision that the at least two beam elements do not output any beam power in a stationary state of the vehicle. Particularly in the stationary state of the vehicle, there is the risk of a person, for example a pedestrian, looking directly into the beam elements from a short distance and therefore being exposed to an increased risk of eye damage. This danger can therefore be avoided.

### BRIEF DESCRIPTION OF THE DRAWINGS

Further preferred embodiments can be found in the dependent claims and the following description of an exemplary embodiment with reference to figures, of which:

FIG. 1 is a schematic view of a beam sensor module according to the invention during the determination of the condition of the road,

FIG. 2 shows a flowchart with a possible sequence of the method according to the invention, and

FIG. 3 shows absorption capabilities of water and ice at three different wavelengths.

### DETAILED DESCRIPTION OF THE INVENTION

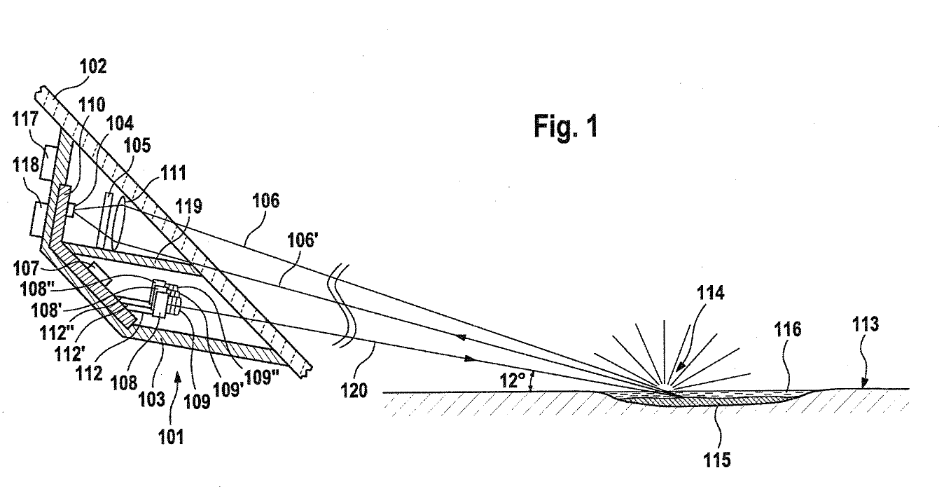

FIG. 1 shows a beam sensor module 101 with a housing 103 which is embodied in such a way that the beam sensor module 101 can be arranged on the inside of the vehicle windshield 102 at the level of the base of the rearview mirror. The windshield 102 closes the open front side in the housing 103. For the sake of clarity, the beam sensor module 101 is shown in cross section in FIG. 1, with the result that the walls of the housing 103 which close the side faces are not illustrated and the view into the interior of the housing 103 is cleared. The beam sensor module 101 also comprises a detector element 104 which is embodied, by way of example, as an indium-gallium-arsenide photodiode, a blocking filter 105 for reducing the incidence of interference influences caused by daylight on the detector element 104, a collecting lens 111 which focuses reflected sensor beams 106, 106′ and all the sensor beams (not illustrated) running between the sensor beams 106 and 106′ in order to generate a higher light intensity on the detector element 104, an analysis module 107 for analyzing the reflected sensor beams and for predictively determining the condition of the road, and three beam elements 108, 108′ and 108″ which are embodied as semiconductor lasers with the wavelengths 980 nm, 1310 nm and 1550 nm. Arranged in front of each of the semiconductor lasers 980 nm, 1310 nm and 1550 nm are, in addition, further collimator lenses 109, 109′ and 109″ which focus the light, that is to say sensor beams 120, generated and emitted by semiconductor lasers 108, 108′ and 108″, to form a beam bundle which is largely parallel. The beam elements 108, 108′ and 108″ are separated by separator diaphragms 119 from the detector element 104 in order to avoid scattered radiation from beam elements 108, 108′ and 108″ passing to the detector element 104 and thereby adversely affecting the reliability or accuracy of the determination of the condition of the road. The beam sensor module 101 also includes a circuit board 110 which has the conductor tracks which are necessary for the electrical connection of the detector element 104, analysis module 107 and beam elements 108, 108′ and 108″. In order to ensure a flexible orientation of the beam elements 108, 108′ and 108″, in contrast to the detector element 104 they are not rigidly coupled to the circuit board 110 but instead can be oriented by means of flexible wire connections 112, 112′ and 112″ during the attachment of the beam sensor module 101 to the vehicle windshield 102 in such a way that the road surface 113 is illuminated at the point 114 7 m in front of the windshield and therefore ahead of the vehicle in the direction of travel, by means of sensor beams 120. For example, the angle of incidence of the sensor beams 120 on the road surface 113 at the point 114 is 12°. The different wavelengths (980 nm, 1310 nm and 1550 nm) which are generated by the beam elements 108, 108′ and 108″ and are incident as sensor beams 115 at the point 114 are partially diffusely reflected and partially absorbed there according to this exemplary embodiment. At the point 114 there is an ice layer 115 which is covered by the water layer 116. Since water wavelengths of 1310 nm are absorbed to a comparatively high degree, this wavelength is only weakly reflected at the surface of the water layer 116. Accordingly, the detector element 104 senses the wavelength at 1310 nm only weakly in reflected sensor beams 106 and 106′. The remaining wavelengths at 980 nm and 1310 nm penetrate the water layer 116 comparatively well and impinge against the ice layer 115. The ice layer 115 in turns acts on the wavelength at 1550 nm in a comparatively highly absorbent fashion, with the result that the detector element 104 can also sense the wavelength at 1550 nm only weakly in reflected sensor beams 106 and 106′. In contrast, the wavelength at 980 nm also penetrates the ice layer 115 comparatively well and is finally reflected by the road surface 113 lying under the ice layer 115. Since the detector element 104 therefore senses the wavelength at 980 nm to a comparatively high degree, but the wavelengths at 1310 nm and 1550 nm only comparatively weakly, the analysis module 107 determines for the condition of the road at point 114 that the latter is covered by the ice layer 115 and water layer 116. Owing to the low coefficient of friction of the ice layer 115 which is additionally not visible to a driver, since it is concealed under the water layer 116, point 114 constitutes danger for the vehicle. The information about the condition of the road and the associated low coefficients of friction are passed onto the driving stability system via the connection 117 to the vehicle CAN bus, which driving stability system can therefore already determine the corresponding control values in a predictive fashion and does not have to determine them only when travelling over the point 114. Furthermore, the beam sensor module 101 has the connection 118 to a vehicle energy supply for supplying energy.

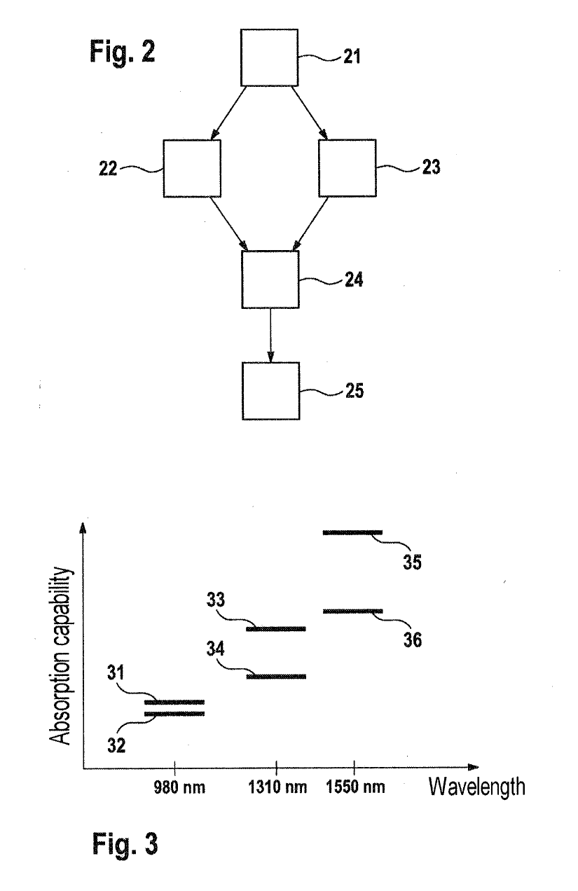

FIG. 2 illustrates a flowchart with a possible sequence of the method according to the invention for predictively determining the condition of the road in a vehicle. In method step 21, the road surface is illuminated with sensor beams, wherein the sensor beams are output in a pulsed fashion and do not exceed an average radiation power of 1 mW. In the following method step 22, a first portion of the sensor beams which are incident on the road surface is absorbed by the road surface, and in step 23 a second portion of the sensor beams which are incident on the road surface is reflected by the road surface. The reflected sensor beams are finally sensed in step 24 by means of a detector element, and in step 25 the condition of the road ahead of the vehicle is determined by means of an analysis module on the basis of intensities of the different wavelengths in the reflected sensor beams. The determination is carried out by means of what is referred to as a support vector method.

FIG. 3 shows the absorption capabilities of water and ice for three different wavelengths of electromagnetic radiation. On the Y axis, the absorption capability is plotted here, and the wavelengths 980 nm, 1310 nm and 1550 nm are illustrated on the X axis. The illustration of the absorption capabilities is not true to scale. As can be seen, the wavelength at 980 nm is absorbed overall most weakly, wherein the absorption capability of water 31 is somewhat more pronounced here than the absorption 1Q capability of ice 32. The wavelength at 1310 nm is absorbed more strongly both by water 33 and by ice 34 than the wavelength at 980 nm. In addition, the absorption capability of water 33 at 1310 nm is significantly stronger than that of ice 34. The absorption capability of water 35 and ice 36 is even stronger at the wavelength of 1550 nm. In contrast to the abovementioned wavelengths, the wavelength at 1550 nm of ice 35 is, however, absorbed to a greater degree than by water 36.

1. A method for predictively determining the condition of a road in a vehicle in which a road surface is illuminated with sensor beams, wherein the sensor beams are reflected and absorbed in accordance with a condition of the road surface, and wherein the condition of the road is determined on the basis of the reflected sensor beams,
wherein the road surface is illuminated in front of the vehicle in the direction of travel.

2. The method as claimed in claim 1, wherein the road surface is illuminated and the reflected sensor beams are sensed in a synchronized pulsed fashion.

3. The method as claimed in claim 1, wherein the sensor beams comprise different wavelengths, with maximum intensity values at at least two different wavelengths.

4. The method as claimed in claim 3, wherein the condition of the road is determined on the basis of intensity values of the different wavelengths in the reflected sensor beams.

5. The method as claimed in claim 4, wherein the different wavelengths in the reflected sensor beams are assigned to the condition of the road by stochastic assignment methods.

6. The method as claimed in claim 1, wherein a specific condition of the road is passed on to at least one driving stability control system and/or driving dynamics control system, in particular to an anti-lock brake system and/or an electronic stability program and/or a ride level control system, and
wherein the at least one driving stability control system and/or driving dynamics control system carries out control which is adapted in a location-synchronous fashion by the specific condition of the road.

7. A beam sensor module for predictively determining the condition of the road in a vehicle, comprising:
at least two beam elements,
at least one detector element,
an analysis module and
a sensor housing,
wherein the at least two beam elements illuminate a road surface with sensor beams, where the sensor beams are reflected and absorbed in accordance with a condition of the road surface,
wherein the at least one detector element senses the reflected sensor beams, and wherein the analysis module determines the condition of the road on the basis of the reflected sensor beams sensed by at least one detector element, and
wherein the sensor housing is adapted to attach to an inner side of a vehicle windshield.

8. The beam sensor module as claimed in claim 7,
wherein the beam elements are semiconductor lasers with different wavelengths in the wavelength range from 900 nm to 1700 nm, with maximum intensity values at the wavelengths 980 nm and/or 1310 nm and/or 1550 nm.

9. The beam sensor module as claimed in claim 7, wherein a radiation power of the at least two beam elements does not exceed 1 mW in each case, and
wherein the radiation power is at an outer side of the windshield.

10. The beam sensor module as claimed in claim 9, wherein the beam power is output in a pulsed fashion.

11. The beam sensor module as claimed in claim 9, wherein the detector element determines a portion of the beam power which is reflected back into the beam sensor module by the windshield, and the beam sensor module controls the beam power at the outer side of the windshield on the basis of the portion which is reflected back.

12. The beam sensor module as claimed in claim 7, wherein the beam sensor module comprises, for each beam element, a separate detector element whose respective maximum sensitivity value corresponds to the wavelength of the maximum intensity value of the respective beam element.

13. The beam sensor module as claimed in claim 7, wherein the detector element is an indium-gallium-arsenide-based photodiode or a germanium-based photodiode.

14. The beam sensor module as claimed in claim 7, wherein the beam sensor module also comprises a blocking filter for visible light, which blocking filter screens the detector element.

15. The beam sensor module as claimed in claim 7, wherein the beam sensor module also comprises at least one collecting lens which focuses the reflected sensor beams onto the at least one detector element.

16. The beam sensor module as claimed in claim 7, wherein the beam sensor module comprises a connection to a vehicle bus, and passes on information about a detected condition of the road to at least one further vehicle system.

17. The beam sensor module as claimed in claim 7, wherein the at least two beam elements do not output any beam power in a stationary state of the vehicle.

18. The beam sensor module as claimed in claim 7, wherein the beam sensor module executes a method for predictively determining a condition of a road in a vehicle in which a road surface is illuminated with sensor beams,
wherein the sensor beams are reflected and absorbed in accordance with a condition of the road surface,
wherein the condition of the road is determined on the basis of the reflected sensor beams, and
wherein the road surface is illuminated in front of the vehicle in the direction of travel.

19. The method as claimed in claim 2, wherein the sensor beams comprise different wavelengths, with maximum intensity values at at least two different wavelengths.

20. The method as claimed in claim 4, wherein the different wavelengths in the reflected sensor beams are assigned to the condition of the road by a support vector method and/or a k-means algorithm.

21. The method as claimed in claim 1, wherein a specific condition of the road is passed on to at least one of an anti-lock brake system, an electronic stability program, and a ride level control system, and
wherein the at least one driving stability control system and/or driving dynamics control system carries out control which is adapted in a location-synchronous fashion by the specific condition of the road

22. The beam sensor module as claimed in claim 8, wherein a radiation power of the at least two beam elements does not exceed 1 mW in each case, wherein the radiation power is determined at an outer side of the windshield.
